(19) United States
(12) Patent Application Publication
(10) Pub. No.: US 2020/0143209 A1
(43) Pub. Date: May 7, 2020

(54) TASK DEPENDENT ADAPTIVE METRIC FOR CLASSIFYING PIECES OF DATA

(71) Applicant: Element AI Inc., Montreal (CA)

(72) Inventors: Alexandre LACOSTE, Montreal (CA); Boris ORESHKIN, Montreal (CA)

(21) Appl. No.: 16/677,077

(22) Filed: Nov. 7, 2019

Related U.S. Application Data
(60) Provisional application No. 62/756,927, filed on Nov. 7, 2018.

(51) Int. Cl. G06K 9/62; G06N 20/00; G06F 16/55

(52) U.S. Cl. CPC G06K 9/6265; G06K 9/6257; G06F 16/55; G06K 9/6272; G06N 20/00

(57) ABSTRACT

Systems and methods relating to machine learning by using a sample data set to learn a specific task and using that learned task on a query data set. In an image classification implementation, a sample set is used to derive a task representation and the task representation is used with a task embedding network to determine parameters to be used with a neural network to perform the task. Once the parameters have been derived, the sample set and the query set are passed through neural network with the parameters. The results are then compared for similarities.

### RELATED APPLICATIONS

This application is a US Non-Provisional patent application which claims the benefit of U.S. Provisional Patent Application No. 62/756,927 filed on Nov. 7, 2018.

### TECHNICAL FIELD

The present invention relates to machine learning. More specifically, the present invention provides systems and methods for learning a specific task using a sample set of data and performing the same task on a query set of data.

### BACKGROUND

Recent advances in computer and software technology have led to the ability for computers to identify unlabelled digital images and to place them into appropriate categories. Despite proper programming, errors still occur, and the goal is to improve their accuracy and to minimize occurring errors. This is accomplished via the combination of using computer vision and pattern recognition as well as artificial intelligence (AI).

Since AI is being utilized to perform image and pattern recognition, it is beneficial to refer to a database of known images that have been previously categorized. The computer acquires the ability to learn from previous examples, thereby increasing its efficiency and accuracy.

Since the world is comprised of a multitude of objects, articles, and entities, large quantities of images that have previously been categorized would greatly assist properly accomplishing this task. The categorized images are then compiled as training data. The system's logic, whether implemented as a convolutional neural network or as some other form of artificial intelligence, then learns to place the images into the proper categories.

Current systems are available for the above described tasks, but they have limitations and their accuracy rate is insufficient. Contemporary systems are improperly trained and have difficulty making generalizations when only a small number of labelled images are available for them to refer to.

Based on the above, there is therefore a need for systems and methods which would allow for such current systems to accurately categorize images from a small sample, referred to as “few-shot learning”. Few-shot learning has become essential for producing models that generalize from few examples, and aims to produce models that can generalize from small amounts of labeled data. In the few-shot setting, one aims to learn a model that extracts information from a set of labeled examples (sample set) to label instances from a set of unlabeled examples (query set).

### SUMMARY

The present invention provides systems and methods relating to machine learning by using a sample data set to learn a specific task and using that learned task on a query data set. In an image classification implementation, a sample set is used to derive a task representation and the task representation is used with a task embedding network to determine parameters to be used with a neural network to perform the task. Once the parameters have been derived, the sample set and the query set are passed through neural network with the parameters. The results are then compared for similarities. A resulting similarity metric is then scaled using a learned value and passed through a softmax function.

In a first aspect, the present invention provides a system for performing a task, the system comprising:
a task representation stage for representing said task and for encoding a representation of said task using a set of generated parameters;
a task execution stage for executing said task on a query set using said parameters and for executing said task on a sample set, outputs of said tasks being compared to determine a similarity metric; and
an output definition stage for scaling said similarity metric using a learnable value.

In another aspect, the present invention provides a method for learning a specific task using a sample set and applying said specific task to a query set, the method comprising:
a) receiving said sample set and said query set;
b) passing said sample set through a task representation stage to generate a set of generated parameters for a feature extractor;
c) processing said sample set and said query set using a task execution stage such that said sample set and said query set are passed through said feature extractor conditioned on said generated parameters;
d) sending results of step c) through a similarity block to determine similarities between an output from said sample set and an output from said query set to result in a similarity metric; and
e) sending results of step d) through an output definition stage to scale said similarity metric.

### BRIEF DESCRIPTION OF THE DRAWINGS

The present invention will now be described by reference to the following figures, in which identical reference numerals refer to identical elements, and in which:

FIG. 1 is a block diagram of a system according to one aspect of the present invention;

FIG. 2 is a block diagram of a Task Embedding Network (TEN) block as used in one implementation of the present invention;

FIG. 3 is a block diagram illustrating the structure of a convolutional block with a Task Embedding Network;

FIG. 4 details the structure of a specific implementation of a feature extractor block that incorporates a Task Embedding Network;

FIG. 5 are metric scale parameter cross-validation results using various datasets.

### DETAILED DESCRIPTION

In one aspect, the present invention provides an improved methodology related to image processing for the purpose of image categorization as it relates to few-shot learning. Given the small number of available images, it is impossible to create a reference database to be used as training data sets for training models that recognize and categorize the images appropriately.

In one aspect, the invention improves the accuracy of properly categorizing small sample sets of images. A sample set and a query set are used with a neural network and nearest neighbor classification is applied. The invention takes into account the fact that interaction between the identified components leads to significant improvements in the few-shot generalization. It demonstrates that a non-trivial interaction between the similarity metric and the cost function can be exploited to improve the performance of a given similarity metric via scaling.

It should be clear that the present invention relates to convolutional neural networks and it should be clear to a person skilled in the art that convolutional neural networks are multilevel, multi-layer software constructs that take in input and produces an output. Each level or layer in the neural network will have one or more nodes and each node may have weights assigned to it. The nodes are activated or not depending on how the neural network is configured. The output of the neural network will depend on how the neural network has been configured, which nodes have been activated by the input, and the weights given to the various nodes. As an example, in the field of image identification, an object classifier convolutional neural network will have, as input, an image, and the output will be the class of objects to which the item in the image will belong to. In this example, the classifier “recognizes” the item or items in the image and outputs one or more classes of items to which the object or objects in the image should belong to.

It should also be clear that neural network behaviour will depend on how the neural network is “trained”. Training involves a data training set that is fed into the neural network. Each set of data is fed into the neural network and the output for each set of training data is then assessed for how close it (the output) is to a desired result. As such, if an image of a dog is fed into a classifier neural network being trained and the output is “furniture” (i.e. the object in the image (the dog) is to be classified as “furniture”), then clearly the classifier neural network needs further training.

Once the output of the neural network being trained has been assessed as to closeness from a desired result, then the parameters within the neural network are adjusted. The training data set is then, again, sent to the neural network and the output is, again, assessed to determine distance from or closeness to the desired result. The process is repeated until the output is acceptably close to the desired result. The adjustments and/or parameters of the neural network that produced the result that is acceptable, are then saved. A new data training set can then be used for more training so that the output or result is even closer to the desired result.

As can be imagined, depending on the configuration of the neural network, there could be hundreds of levels or layers within the network, with each layer having potentially hundreds of nodes. Since each node may have a weight associated with it, there could be a multitude of potential parameters that can be adjusted during training. The weight associated with each node may be adjusted to emphasize the node's effect, or it may be adjusted to de-emphasize that nodes' effect or to even negate whatever effect the node may have. Of course, each node may be one in a decision tree towards an outcome or each node may be a step that effects a change on some piece of data (e.g. the input).

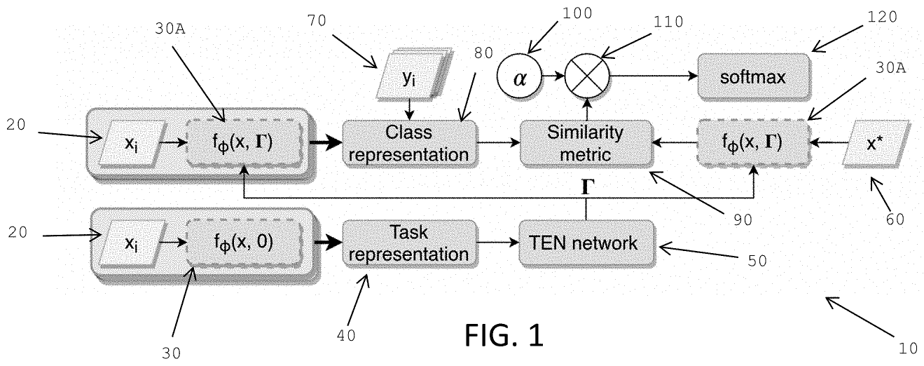

Referring now to FIG. 1, a block diagram of a system according to one aspect of the invention is illustrated. As can be seen, a similarity metric is introduced into the process to enhance the outcome and to improve upon the accuracy of the final results. In FIG. 1, the system 10 uses the sample set 20 along with a feature extractor block 30 to determine a task representation 40. The task representation is then used in a task embedding network 50 to determine the proper parameters to be used when completing the task with the sample set 20. These proper parameters, now part of the extractor block 30A, are then used to process the sample set 20 and the query set 60. The result of the extractor block 30A used with the sample set 20 are the features of the sample set observations xᵢ. This is combined with the class yᵢ 70 for that observation to result in the representation 80 for that class. The result of the extractor block 30A used with the query set 60 are also representations for specific classes from the query set. This output is then compared with the representation 80 to result in a similarity metric 90. The similarity metric 90 is an indication of how similar are the outputs of the extractor blocks 30A using different data sets. The similarity metric is then scaled using a learnable value 100 using a multiplier 110. The output of the multiplier 110 is then passed through a softmax function 120.

From FIG. 1, it can be seen that the system can be broken down into multiple stages. A task representation stage (with blocks 20, 30, 40, and 50) extracts the task representation and determines the parameters for use with the feature extractor. The task execution stage (using blocks 30A, 80, 90, and the datasets 20, 30) performs the actual execution of the task. An output definition stage (with the value 100 and multiplier 110) then scales the output of the previous stage accordingly.

In the present invention, the problem of few-shot learning is addressed using a learning algorithm. As can be seen from FIG. 1, one aspect of the invention uses two different components: (i) the task information from the sample set S via observations xᵢ∈ [symbol] ^{D}^{ₓ} and their respective class labels [symbol] ᵢ∈{1, . . . , C}, and (ii) a query set [symbol] ={(xᵢ,yᵢ)}ᵢ₌₁^{q} for a task to be solved in a given episode.

As further explanation of the present invention, consider the episodic K-shot, C-way classification scenario. A learning algorithm is provided with a sample set S={(xᵢ,yᵢ)}ᵢ₌₁^{KC} consisting of K examples for each of C classes, and a query set [symbol] ={(xᵢ,yᵢ)}ᵢ₌₁^{q} for a task to be solved in a given episode. The sample set provides the task information via observations xᵢ∈ [symbol] ^{D}^{ₓ} and their respective class labels yᵢ∈{1, . . . , C}. Given the information in the sample set S, the learning algorithm is able to classify individual samples from the query set [symbol] . A similarity measure is then defined as d: [symbol] ^{2D}^{_{z}}→ [symbol] . Note that d does not have to satisfy the classical metric properties (non-negativity, symmetry, and subadditivity) to be useful in the context of few-shot learning. The dimensionality of metric input, D_{z} is related to the size of embedding created by a (deep) feature extractor f_{ϕ}: [symbol] ^{D}^{ₓ}→ [symbol] ^{D}^{_{z}}, parameterized by ϕ, mapping x to z. Here ϕ∈ [symbol] ^{D}^{_{ϕ}} is a list of parameters defining f_{ϕ}. The set of representations (f_{ϕ}(xᵢ),yᵢ,∀(xᵢ,yᵢ)∈S can directly be used to solve the few-shot learning classification problem by association. To learn ϕ, they minimize −log p_{ϕ}(y=k|x) using the softmax over prototypes cₖ to define the likelihood: p_{ϕ}(y=k|x)=softmax(−d(f_{ϕ}(x),cₖ)).

In the above formulations, S denotes the sample set, and [symbol] denotes the query set.

Other aspects of the present invention include applying metric scaling, task conditioning, and auxiliary task co-training. The present invention shows that learning a scaling factor α after applying the distance function d helps the softmax function operate in the proper regime. As well, it has been found that the choice of the distance function d has much less influence when the proper scaling is used. A task encoding network is used to extract a task representation based on the task's sample set. This is used to influence the behavior of the feature extractor through FILM (see E. Perez, F. Strub, H. De Vries, V. Dumoulin, and A. Courville. Film: Visual reasoning with a general conditioning layer, in AAAI, 2018. The contents of this document are incorporated herein in their entirety by reference). It is also shown that co-training the feature extraction on a conventional supervised classification task reduces training complexity and provides better generalization.

Three main approaches have been used in the past to solve the few-shot classification problem. The first one is the meta-learning approach, which produces a classifier that generalizes across all tasks. This is the case of Matching Networks, which use a Recurrent Neural Network (RNN) to accumulate information about a given task (see O. Vinyals, C. Blundell, T. Lillicrap, K. Kavukcuoglu, and D. Wierstra. Matching networks for one shot learning. In NIPS, pages 3630-3638. 2016. The contents of this document are incorporated herein in their entirety by reference). The second approach aims to maximize the distance between examples from different classes. Similarly, a contrastive loss function is used to learn to project data onto a manifold that is invariant to deformations in the input space. Triplet loss is used for learning a representation for few-shot learning. The attentive recurrent comparators use a recurrent architecture to learn to perform pairwise comparisons and predict if the compared examples belong to the same class. The third class of approaches relies on Bayesian modeling of the prior distribution of the different categories.

In the present invention, it was discovered that the Euclidean distance outperformed the cosine distance due to the interaction of the different scaling of the metrics with the softmax function, and that the dimensionality of the output has a direct impact on the output scale for the Euclidean distance. In the equation z˜ [symbol] (0,I), [symbol] _{z}[∥z∥₂²]=D_{f}, if D_{f} is large, the network may have to work outside of its optimal regime to be able to scale down the feature representation. The distance metric is scaled by a learnable temperature, α,p_{ϕα}(y=k|x)=softmax(−αd(z,cₖ)) to enable the model to learn the best regime for each similarity metric, thereby improving the performances of all metrics.

In the present invention, a dynamic task-conditioned feature extractor is better suited for finding correct associations between given sample set class representations and query samples. It defines the dynamic feature extractor f_{ϕ}(x,Γ), where Γ is the set of parameters predicted from a task representation such that the performance of f_{ϕ}(x, Γ) is optimized given the task sample set S. This is related to the FILM conditioning layer and conditional batch normalization of the form hₗ₊₁=γhₗ+β, where γ and β are scaling and shift vectors applied to the layer hₗ. In the present invention, the mean of the class prototypes is used as the task representation,

$$\overline{c} = \frac{1}{C} {\sum }_{k} {c}_{k}$$

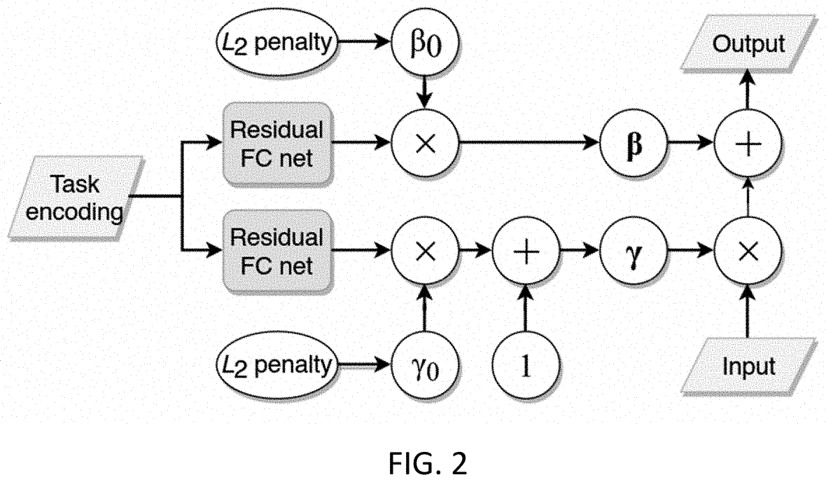

and this task representation is encoded with a Task Embedding Network (TEN). In addition, the present invention predicts layer-level element-wise scale and shift vectors γ, β for each convolutional layer in the feature extractor (see FIGS. 2-4).

The Task Embedding Network (TEN) used in one implementation of the present invention uses two separate fully connected residual networks to generate vectors γ, β. The parameter is learned in the delta regime, (i.e. predicting deviation from unity). One component of importance when successfully training the TEN is the addition of the post-multipliers γ₀ and β₀, both of which are penalized by the scalar L₂. These post-multipliers limit the effect of γ (and β) by encoding a condition that all components of γ (and β) should be simultaneously close to zero for a given layer unless task conditioning provides a significant information gain for this layer. Mathematically, this can be expressed as β=β₀g_{θ}(c̅) and γ₀h_{φ}(c̅)+1, where g_{θ} and h_{φ} are predictors of β and γ.

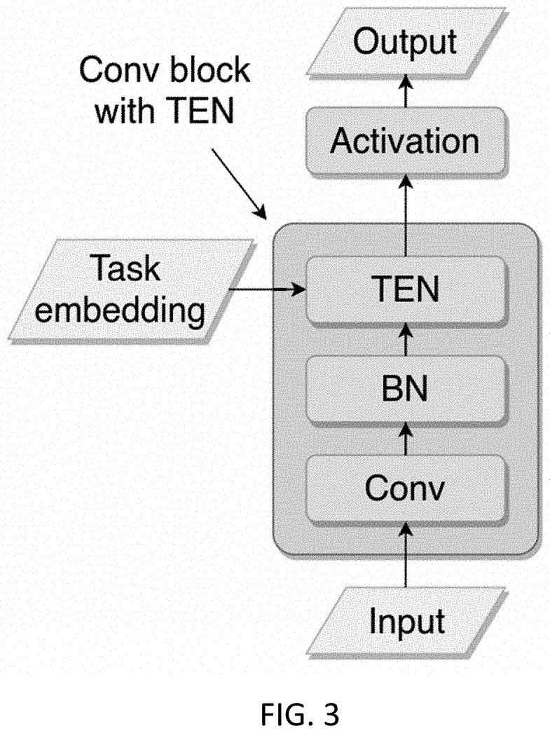

The detailed architecture of the TEN block is shown in FIG. 2. This implementation of the TEN block uses two separate fully connected residual networks to generate vectors γ, β. The number of layers was cross-validated to be three. The first layer projects the task representation into the target width. The target width is equal to the number of filters of the convolutional layer that the TEN block is conditioning (see FIG. 3). The remaining layers operate at the target width and each of them has a skip connection. The L₂ regularizer weight for γ₀ and β₀ was cross-validated at 0.01 for each layer. It was found that smaller values led to considerable overfit and that, to train the TEN block, γ₀ and β₀ were necessary as the training tended to get stuck in local minima. Within this local minima, the overall effect of introducing the TEN block was detrimental to the few-shot performance of the architecture.

In terms of implementing the system illustrated in FIG. 1, the ResNet-12 (see K. He, X. Zhang, S. Ren, and J. Sun. Deep residual learning for image recognition. CVPR, pages 770-778, 2016. The contents of this document are incorporated herein in their entirety by reference) was used as the backbone feature extractor. This network has 4 blocks of depth 3 with 3×3 kernels and shortcut connections. A 2×2 max-pool is applied at the end of each block. Convolutional layer depth starts with 64 filters and is doubled after every max-pool. Once this aspect of the invention was implemented, on the first pass over sample set, the TEN predicts the values of γ and β parameters for each convolutional layer in the feature extractor from the task representation. Next, the sample set and the query set are processed by the feature extractor conditioned with the values of γ and β just generated. Both outputs are fed into a similarity metric to find an association between class prototypes and query instances. The output of similarity metric is scaled by scalar α and is fed into a softmax layer.

The Task Embedding Network (TEN) introduces additional complexity into the architecture of the system via task conditioning layers inserted after the convolutional and batch norm blocks. Simultaneously optimizing convolutional filters and the TEN is solved by auxiliary co-training with an additional logit head (64-way classification in mini-Imagenet case). The auxiliary task is sampled with a probability that is annealed over episodes. The annealing used is an exponential decay schedule of the form 0.9^{└20t/T┘}, where T is the total number of training episodes, and t is episode index. In the present invention, the initial auxiliary task selection probability was cross-validated to be 0:9 and the number of decay steps was chosen to be twenty.

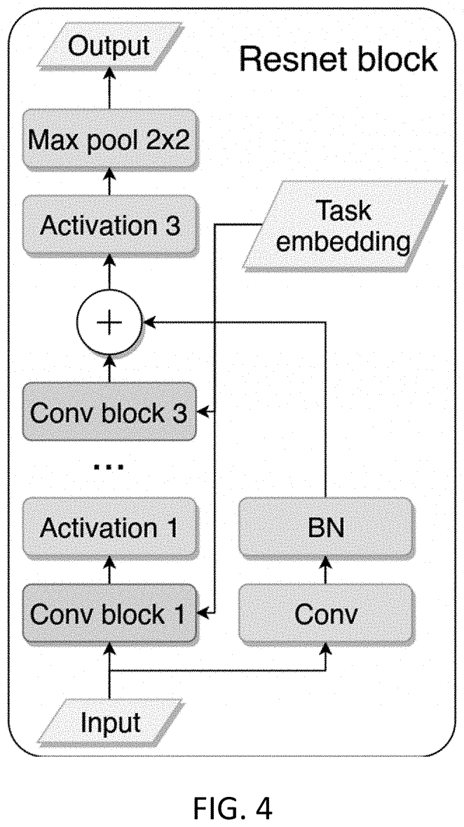

Regarding further details of the implementation of the system in FIG. 1, the resnet blocks used in the ResNet-12 feature extractor are shown in FIGS. 3 and 4. The feature extractor consists of four resnet blocks shown in FIG. 4 followed by a global average-pool. Each resnet block consists of three convolutional blocks (shown in FIG. 3) followed by a 2×2 max-pool. Each convolutional layer is followed by a batch norm (BN) layer and the swish-1 activation function. It was found that the fully convolutional architecture performs best as a few-shot feature extractor, both on the mini-Imagenet data set and on the FC100 data set. It was also found that inserting additional projection layers after the ResNet stack was detrimental to the few-shot performance.

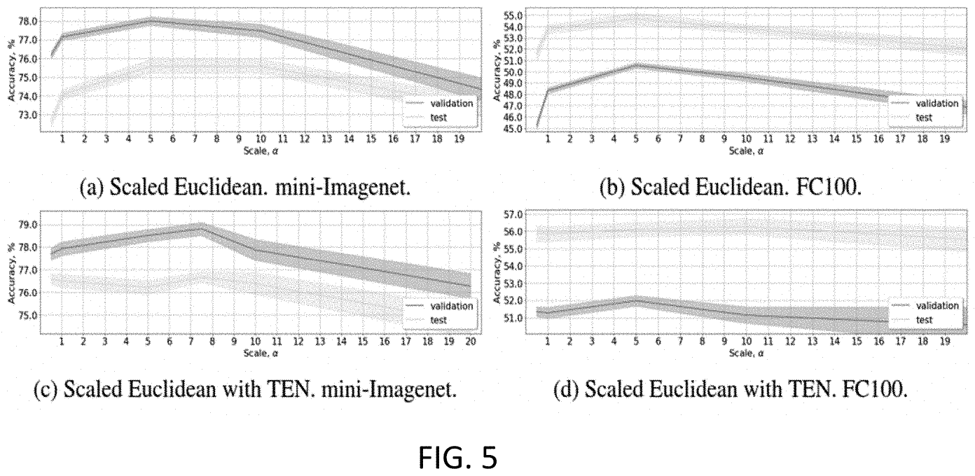

This result was cross-validated with multiple hyper-parameter settings for the projection layers (number of layers, layer widths, and dropout). In addition to that, it was observed that adding extra convolutional layers and max-pool layers before the ResNet stack was detrimental to the few-shot performance. Because of this, a fully convolutional, fully residual architecture was used in the present invention. The results of the cross-validation are shown in FIG. 5. These results show that there is an optimal value of the metric scaling parameter (α) for a given combination od dataset and metric. This is reflected in the inverse U-shape of the curves in the Figure.

The hyperparameters for the convolutional layers are as follows—the number of filters for the first ResNet block was set to sixty-four and it was doubled after each max-pool block. The L₂ regularizer weight was cross-validated at 0.0005 for each layer.

To test the system, two datasets were used: the mini-Imagenet dataset and the Fewshot-CIFAR100 dataset (referred to as FC100 in this document). For details regarding the mini-Imagenet dataset, reference should be made to Vinyals et al. (see O. Vinyals, C. Blundell, T. Lillicrap, K. Kavukcuoglu, and D. Wierstra. Matching networks for one shot learning. In NIPS, pages 3630-3638. 2016. The contents of this document are incorporated herein in their entirety by reference.) The results for these datasets are provided in Table 1 below. Table 1 shows the average classification accuracy (%) with 95% confidence interval on the five-way classification task and training with the Euclidean distance. The scale parameter is cross-validated on the validation set. For clarity, AT refers to auxiliary co-training and TC refers to task conditioning with TEN.

TABLE 1

| | | | mini-Imagenet | | | FC100 | | |
|---|---|---|---|---|---|---|---|---|
| α | AT | TC | 1-shot | 5-shot | 10-shot | 1-shot | 5-shot | 10-shot |
| | | | 56.5 ± 0.4 | 74.2 ± 0.2 | 78.6 ± 0.4 | 37.8 ± | 53.3 ± | 58.7 ± |
| | | | | | | 0.4 | 0.5 | 0.4 |
| ✓ | | | 56.8 ± 0.3 | 75.7 ± 0.2 | 79.6 ± 0.4 | 38.0 ± | 54.0 ± | 59.8 ± |
| | | | | | | 0.3 | 0.5 | 0.3 |
| ✓ | ✓ | | 58.0 ± 0.3 | 75.6 ± 0.4 | 80.0 ± 0.3 | 39.0 ± | 54.7 ± | 60.4 ± |
| | | | | | | 0.4 | 0.5 | 0.4 |
| ✓ | | ✓ | 54.4 ± 0.3 | 74.6 ± 0.3 | 78.7 ± 0.4 | 37.8 ± | 54.0 ± | 58.8 ± |
| | | | | | | 0.2 | 0.7 | 0.3 |
| ✓ | ✓ | ✓ | 58.5 ± 0.3 | 76.7 ± 0.3 | 80.8 ± 0.3 | 40.1 ± | 56.1 ± | 61.6 ± |
| | | | | | | 0.4 | 0.4 | 0.5 |

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for performing a task, the system comprising:
a task representation stage for representing said task and for encoding a representation of said task using a set of generated parameters;
a task execution stage for executing said task on a query set using said parameters and for executing said task on a sample set, outputs of said tasks being compared to determine a similarity metric; and
an output definition stage for scaling said similarity metric using a learnable value.

2. The system according to claim 1, wherein said task representation stage and said task execution stage both use at least one instance of a dynamic feature extractor as applied to said sample set, said task execution stage using said dynamic feature extractor with parameters predicted from said representation.

3. The system according to claim 1, wherein said task is classification related and said representation of said task is a mean of class prototypes used for classification in said task.

4. The system according to claim 2, wherein said task execution stage further uses said dynamic feature extractor with said parameters predicted from said representation with said query set.

5. The system according to claim 2, wherein said parameters predicted from said representation for said dynamic feature extractor are predicted such that a performance of said feature extractor is optimized given the sample set.

6. The system according to claim 2, wherein said system uses predicted layer-level element-wise scale and shift vectors for each convolutional layer in said dynamic feature extractor.

7. The system according to claim 6, wherein said task representation stage uses a task embedding network (TEN) comprising at least two fully connected residual networks to generate said scale and shift vectors.

8. The system according to claim 1, wherein said system operates by implementing a method comprising:
a) receiving said sample set and said query set;
b) passing said sample set in said task representation stage to generate said set of generated parameters for a feature extractor;
c) processing said sample set and said query set using said task execution stage such that said sample set and said query set are passed through said feature extractor conditioned on said generated parameters;
d) sending results of step c) through a similarity block to determine similarities between an output from said sample set and an output from said query set to result in said similarity metric; and
e) sending results of step d) through said output definition stage to scale said similarity metric.

9. The system according to claim 8, wherein a result of step e) is processed to result in a probability distribution over a plurality of different possible outcomes.

10. The system according to claim 9, wherein processing to result in said probability distribution is accomplished by passing said result of step e) through a softmax function.

11. The system according to claim 1, wherein said task is image related.

12. The system according to claim 11, wherein said task is classification related.

13. A method for learning a specific task using a sample set and applying said specific task to a query set, the method comprising:
a) receiving said sample set and said query set;
b) passing said sample set through a task representation stage to generate a set of generated parameters for a feature extractor;
c) processing said sample set and said query set using a task execution stage such that said sample set and said query set are passed through said feature extractor conditioned on said generated parameters;
d) sending results of step c) through a similarity block to determine similarities between an output from said sample set and an output from said query set to result in a similarity metric; and
e) sending results of step d) through an output definition stage to scale said similarity metric.

14. The system according to claim 13, wherein a result of step e) is processed to result in a probability distribution over a plurality of different possible outcomes.

15. The system according to claim 14, wherein processing to result in said probability distribution is accomplished by passing said result of step e) through a softmax function.

16. The system according to claim 13, wherein said task is image related.

17. The system according to claim 13, wherein said task is classification related.
